(19) United States
(12) Patent Application Publication
(10) Pub. No.: US 2025/0048393 A1
(43) Pub. Date: Feb. 6, 2025

(54) SIDELINK CONTROL INFORMATION (SCI) FOR SIDELINK-POSITIONING REFERENCE SIGNAL (SL-PRS)

(71) Applicant: QUALCOMM Incorporated, San Diego, CA (US)

(72) Inventors: Alexandros Manolakos, Athens (GR); Mukesh Kumar, Hyderabad (IN); Kianoush Hosseini, San Diego, CA (US); Srinivas Yerramalli, San Diego, CA (US)

(21) Appl. No.: 18/716,089

(22) PCT Filed: Dec. 19, 2022
(86) PCT No.: PCT/US2022/081957

§ 371 Date: Jun. 3, 2024

(30) Foreign Application Priority Data
Feb. 4, 2022 (GR) 20220100117

(51) Int. Cl. H04W 72/25; H04L 5/00; H04W 72/51

(52) U.S. Cl. CPC H04W 72/25; H04L 5/0051; H04W 72/51

(57) ABSTRACT

This disclosure provides systems, methods, and devices for wireless communication that support sidelink control information (SCI). In a first aspect, a method of wireless communication includes receiving first SCI, the first SCI including a plurality of fields, and decoding at least one field of the plurality of fields based on a first higher layer parameter to determine sidelink-position reference signal (SL-PRS) information. Other aspects and features are also claimed and described.

### CROSS-REFERENCE TO RELATED APPLICATIONS

This application claims the benefit of Greek Patent Application No. 20220100117, entitled, “SIDELINK CONTROL INFORMATION (SCI) FOR SIDELINK-POSITIONING REFERENCE SIGNAL (SL-PRS),” filed on Feb. 4, 2022, which is expressly incorporated by reference herein in its entirety.

### TECHNICAL FIELD

Aspects of the present disclosure relate generally to wireless communication systems, and more particularly, to sidelink control information (SCI). Some features may enable and provide improved communications, including use of the SCI for a sidelink-positioning reference signal.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

With the introduction of 5^{th} Generation (5G) or new radio (NR) networks (sometimes referred to as “5G NR” networks/systems/devices), UEs are able to have higher capability, higher data rate, higher bandwidth. Additionally, UEs are also able to operate in a variety of architectures that provide dual connectivity. As devices continue to improve and “do more”, scheduling access to a wireless medium and avoiding conflicts becomes more difficult, such as when multiple devices are densely co-located.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a method for wireless communication includes receiving first sidelink control information (SCI). The first SCI includes a plurality of fields. The method also includes decoding at least one field of the plurality of fields based on a first higher layer parameter to determine sidelink-position reference signal (SL-PRS) information.

In an additional aspect of the disclosure, an apparatus includes at least one processor and a memory coupled to the at least one processor. The at least one processor is configured to receive first SCI. The first SCI includes a plurality of fields. The at least one processor is further configured to decode at least one field of the plurality of fields based on a first higher layer parameter to determine SL-PRS information.

In an additional aspect of the disclosure, an apparatus includes means for receiving first SCI. The first SCI includes a plurality of fields. The apparatus further includes means for decoding at least one field of the plurality of fields based on a first higher layer parameter to determine SL-PRS information.

In an additional aspect of the disclosure, a non-transitory computer-readable medium stores instructions that, when executed by a processor, cause the processor to perform operations. The operations include receiving first SCI. The first SCI includes a plurality of fields. The operations further include decoding at least one field of the plurality of fields based on a first higher layer parameter to determine SL-PRS information.

In an additional aspect of the disclosure, an apparatus configured for wireless communication includes an interface, such as a wireless interface, and at least one processor. The interface is configured to receive first SCI. The first SCI includes a plurality of fields. The at least one processor is configured to decode at least one field of the plurality of fields based on a first higher layer parameter to determine SL-PRS information.

In an additional aspect of the disclosure, a method for wireless communication includes generating first SCI. The first SCI includes a plurality of fields. At least one field of the plurality of fields encoded to indicate SL-PRS information. The method further includes transmitting the first SCI.

In an additional aspect of the disclosure, an apparatus includes at least one processor and a memory coupled to the at least one processor. The at least one processor is configured to generate first SCI. The first SCI includes a plurality of fields. At least one field of the plurality of fields encoded to indicate SL-PRS information. The at least one processor is configured to initiate transmission of the first SCI.

In an additional aspect of the disclosure, an apparatus includes means for generating first SCI. The first SCI includes a plurality of fields. At least one field of the plurality of fields encoded to indicate SL-PRS information. The apparatus further includes means for transmitting the first SCI.

In an additional aspect of the disclosure, a non-transitory computer-readable medium stores instructions that, when executed by a processor, cause the processor to perform operations. The operations include generating first SCI. The first SCI includes a plurality of fields. At least one field of the plurality of fields encoded to indicate SL-PRS information. The operations further includes initiating transmission of the first SCI.

In an additional aspect of the disclosure, an apparatus configured for wireless communication includes at least one processor, and an interface, such as a wireless interface coupled to the at least one processor. The at least one processor is configured to generate first SCI. The first SCI includes a plurality of fields. At least one field of the plurality of fields encoded to indicate SL-PRS information. The interface is configured to transmit the first SCI.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more aspects.

FIG. 2 is a block diagram illustrating examples of a base station (BS) and a user equipment (UE) according to one or more aspects.

FIG. 3 is a block diagram illustrating an example wireless communication system that supports sidelink control information (SCI) according to one or more aspects.

FIG. 4 is a block diagram illustrating an example of an SCI-2 according to one or more aspects.

FIG. 5 is a block diagram illustrating an example of an SCI-2 according to one or more aspects.

FIG. 6 is a block diagram illustrating an example of an SCI-2 according to one or more aspects.

FIG. 7 is a block diagram illustrating an example of an SCI-2 according to one or more aspects.

FIG. 8 is a block diagram illustrating an example values of a positioning type session field according to one or more aspects.

FIG. 9 is a flow diagram illustrating an example process that supports SCI according to one or more aspects.

FIG. 10 is a flow diagram illustrating an example process that supports SCI according to one or more aspects.

FIG. 11 is a block diagram of an example UE that supports SCI according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support sidelink control information (SCI). To illustrate, the SCI, such as SCI-1 or SCI-2, may be configured or formatted for sidelink positioning reference signal (SL-PRS) information. For example, a portion of the SCI, such as the SCI-1 having a SCI format 1-A, may be interpreted for SL-PRS. An SCI-1 having SCI format 1-A that has at least a portion interpreted for SL-PRS may be associated with a SCI-2 or may not be associated with an SCI-2 (e.g., no SCI-2 is need to schedule SL-PRS). Additionally, or alternatively, the SCI, such as an SCI-2, may have a format associated with SL-PRS. For example, the SCI-2 may be include a plurality of blocks configured to provide source ID information, destination ID information, positioning type session information, PRS triggering information, or a combination thereof, to one or more destination UEs. In some implementations, a UE may receive a high-layer configuration, such as a higher layer parameter, that indicates to interpret an SCI-1 as the SL-PRS SCI-1 or to interpret an SCI-2, or a portion thereof, as an SL-PRS SCI-2.

Particular implementations of the subject matter described in this disclosure may be implemented to realize one or more of the following potential advantages or benefits. In some aspects, the present disclosure provides techniques for use of the SCI for a sidelink-positioning reference signal, which may reduce overhead and improve system efficiency.

Wireless devices may share access in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.99999% reliability), ultra-low latency (e.g., ˜1 millisecond (ms)), and users with wide ranges of mobility or lack thereof, and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

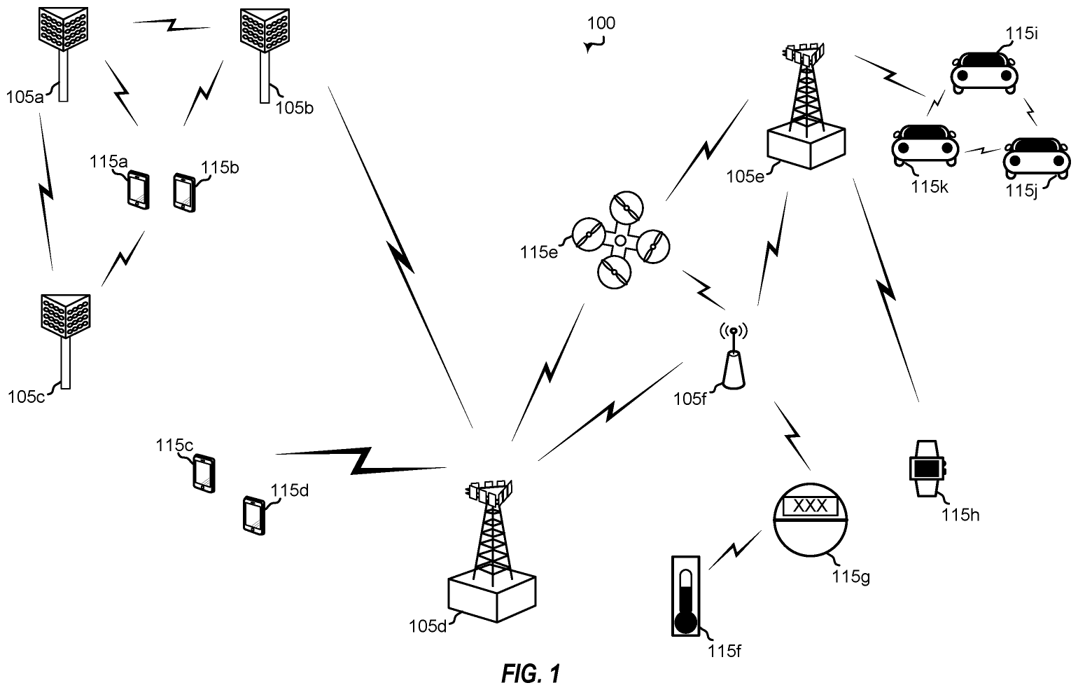

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (SCG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports ultra-reliable and redundant links for devices, such UE 115e. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105e.

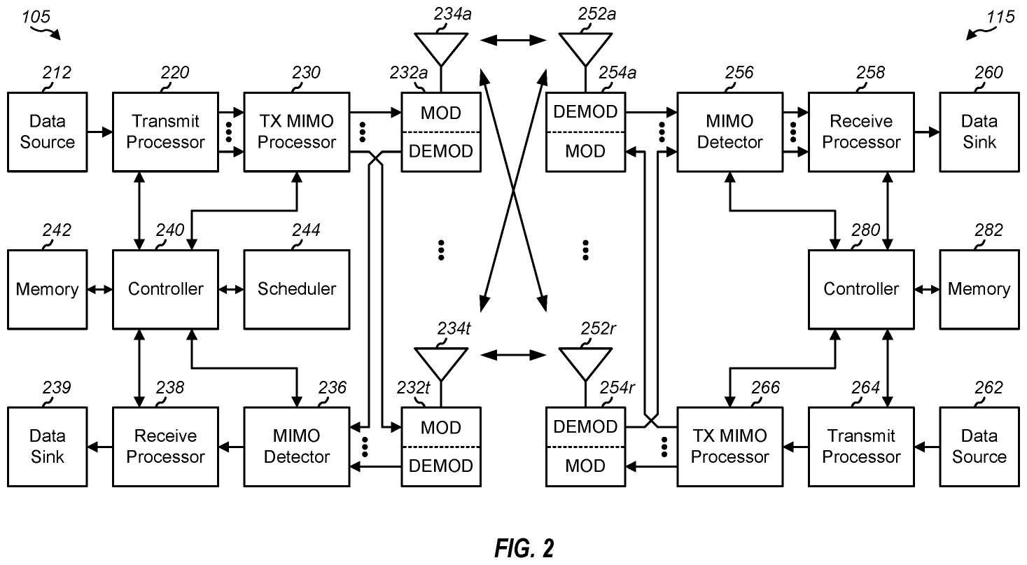

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

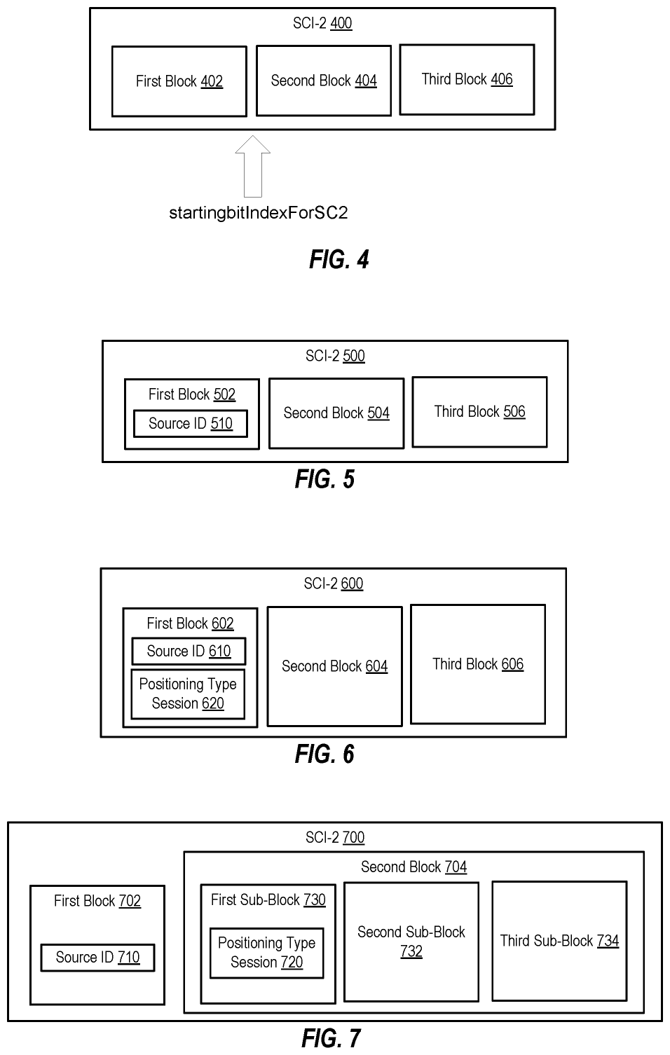

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct the execution illustrated in FIG. 4, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

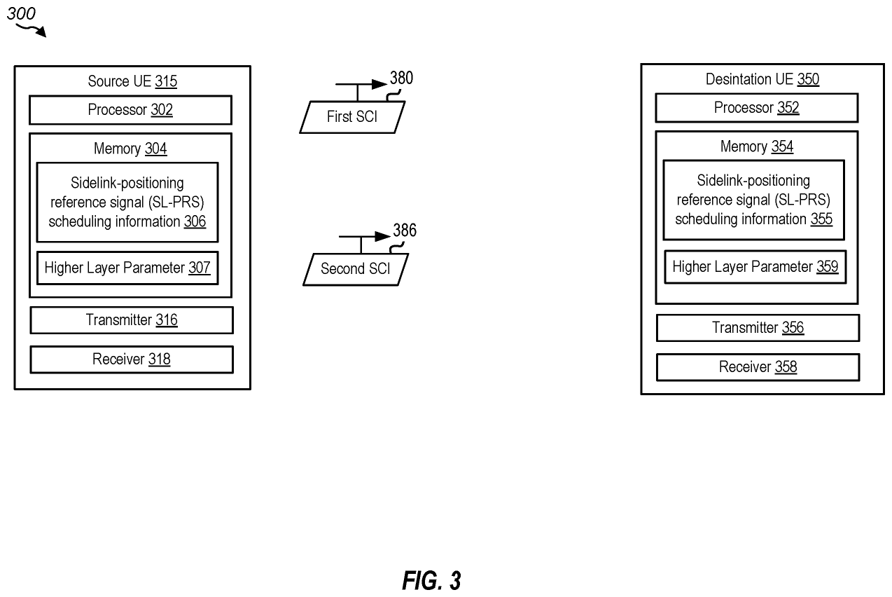

FIG. 3 is a block diagram of an example wireless communications system 300 that supports SCI according to one or more aspects. In some examples, wireless communications system 300 may implement aspects of wireless network 100. Wireless communications system 300 includes a UE 315, such as a source UE, and a UE 350, such as a destination UE. Although two UEs 315 and 350 are illustrated, in some other implementations, wireless communications system 300 may include more than two UEs. Although not shown, in some implementations, wireless communications system 300 may include one or more other devices, such as base station 105.

UE 315 may include a variety of components (such as structural, hardware components) used for carrying out one or more functions described herein. For example, these components may include one or more processors 302 (hereinafter referred to collectively as “processor 302”), one or more memory devices 304 (hereinafter referred to collectively as “memory 304”), one or more transmitters 316 (hereinafter referred to collectively as “transmitter 316”), and one or more receivers 318 (hereinafter referred to collectively as “receiver 318”). Processor 302 may be configured to execute instructions stored in memory 304 to perform the operations described herein. In some implementations, processor 302 includes or corresponds to one or more of receive processor 258, transmit processor 264, and controller 280, and memory 304 includes or corresponds to memory 282.

Memory 304 includes or is configured to store sidelink-positioning reference signal (SL-PRS) scheduling information 306 and a higher layer parameter 307. SL-PRS scheduling information 306 may include or be associated with scheduling or performance of a SL-PRS operation. Higher layer parameter 307 may be received via radio resource control (RRC) signaling or a medium access control-control element (MAC-CE) from another device, such as base station 105.

Transmitter 316 is configured to transmit reference signals, control information and data to one or more other devices, and receiver 318 is configured to receive references signals, synchronization signals, control information and data from one or more other devices. For example, transmitter 316 may transmit signaling, control information and data to, and receiver 318 may receive signaling, control information and data from, UE 350 or base station 105. In some implementations, transmitter 316 and receiver 318 may be integrated in one or more transceivers. Additionally or alternatively, transmitter 316 or receiver 318 may include or correspond to one or more components of UE 315 described with reference to FIG. 2. In some implementations, transmitter 316, receiver 318, or a combination thereof may be referred to as an interface that is configured for wired communication, wireless communication, or a combination thereof.

UE 350 may include a variety of components (such as structural, hardware components) used for carrying out one or more functions described herein. For example, these components may include one or more processors 352 (hereinafter referred to collectively as “processor 352”), one or more memory devices 354 (hereinafter referred to collectively as “memory 354”), one or more transmitters 356 (hereinafter referred to collectively as “transmitter 356”), and one or more receivers 358 (hereinafter referred to collectively as “receiver 358”). Processor 352 may be configured to execute instructions stored in memory 354 to perform the operations described herein. For example, memory 354 may include processor-readable code that, when executed by processor 352, causes processor 352 to preform one or more of the operations described herein. In some implementations, processor 352 includes or corresponds to one or more of receive processor 258, transmit processor 264, and controller 280, and memory 354 includes or corresponds to memory 282.

Memory 354 includes or is configured to store SL-PRS scheduling information 355 and a higher layer parameter 359. SL-PRS scheduling information 355 and higher layer parameter 359 may include or correspond to SL-PRS scheduling information 306 and higher layer parameter 307, respectively.

Transmitter 356 is configured to transmit reference signals, synchronization signals, control information and data to one or more other devices, and receiver 358 is configured to receive reference signals, control information and data from one or more other devices. For example, transmitter 356 may transmit signaling, control information and data to, and receiver 358 may receive signaling, control information and data from, UE 315 or base station 105. In some implementations, transmitter 356 and receiver 358 may be integrated in one or more transceivers. Additionally or alternatively, transmitter 356 or receiver 358 may include or correspond to one or more components of UE 115 described with reference to FIG. 2. In some implementations, transmitter 356, receiver 358, or a combination thereof may be referred to as an interface that is configured for wired communication, wireless communication, or a combination thereof.

In some implementations, wireless communications system 300 implements a 5G NR network. For example, wireless communications system 300 may include multiple 5G-capable UEs 115 and multiple 5G-capable base stations 105, such as UEs and base stations configured to operate in accordance with a 5G NR network protocol such as that defined by the 3GPP.

UE 315 and UE 350 may be configured for sidelink communication. In some implementations, UE 315 and UE 350 may be configured for communication via RRC signaling, a MAC-CE, sidelink control information (SCI), or other signaling or configuration information, as illustrative, non-limiting examples. A UE may receive the RRC signaling or the MAC-CE from a base station, such as base station 105, as an illustrative, non-limiting example. Additionally, or alternatively, UE 315 and UE 350 may be configured to perform one or more sidelink positioning operations. The SCI-1 may be decodable by one or more UEs, such as UEs that are configured to operate according to one or more standards. In some implementations, the SCI-1 is configured to be decodable by UEs in all releases, such as legacy UEs. The SCI-2 formats may be decodable by one or more UEs, such that SCI-2 may support additional functionality that legacy UEs are not configured to perform. This approach for the SCI-1 and the SCI-2 may ensure that new features can be introduce while avoiding resource collisions between releases. In some implementations, both SCI-1 and SCI-2 use the PDCCH polar code.

In some implementations, sidelink control information may include a two stage procedure for forward compatibility. The two stage procedure may include first stage control (SCI-1) which is transmitted on a physical sidelink control channel (PSCCH) and contains information for resource allocation and decoding second stage control, such as second stage control (SCI-2). The second stage control (SCI-2) may be transmitted on a physical sidelink shared channel (PSSCH) and contains information for decoding data, such as SCH.

The SCI-1 may include one or more fields. The one or more fields of SCI-1 may include or indicate a priority (such as a quality of service (QoS) value), PSSCH resource assignment (such as frequency/time resource for PSSCH), a Resource reservation period (if enabled), a PSSCH demodulation reference signal (DMRS) pattern (if more than one patterns are (pre)configured), a second SCI format (such as information on the size of a second SCI), a 2-bit beta offset for 2^{nd}-stage control resource allocation, a number of PSSCH DMRS port(s) (such as 1 port or 2 ports), a 5-bit modulation and coding scheme (MCS), or a combination thereof. In some implementations, the SCI-1 includes a plurality of fields that include a priority field, a frequency resource assignment field, a time resource assignment field, a resource reservation period field, a DMRS pattern field, a second stage sidelink control information format field, a beta offset indicator field, a number of DMRS port field, an MCS field, an MCS table indicator field, a physical sidelink feedback channel (PSFCH) overhead indication field, a reserved field, or a combination thereof, as illustrative, non-limiting examples.

In some implementations, the SCI-1 may have an SCI format 1-A, which may be used for the scheduling of PSSCH or a second stage-SCI on PSSCH. The SCI format 1-A may include priority information, frequency resource assignment information, time resource assignment information, resource reservation period information, DMRS pattern information, second stage SCI format information, beta offset indicator information, a number of DMRS ports, MCS information, an MCS table indicator, PSFCH overhead indication information, reserved information, or a combination thereof.

In some implementations, the priority information of the SCI format 1-A may include 3 bits. The 3 bits may be specified as defined at least with reference to clause 5.4.3.3 Priority Level of 3GPP TS 23.287 version 16.3.0 Release 16 or clause 5.22.1.3.1 Sidelink HARQ Entity of 3GPP TS 38.321 version 16.1.0 Release 16.

The frequency resource assignment information of the SCI format 1-A may include

$$⌈ {log}_{2} ( \frac{{N}_{s u b C hannel}^{S L} ( {N}_{subChannel}^{S L} + 1 )}{2} ) ⌉$$

bits when the value of the higher layer parameter sl-MaxNumPerReserve is configured to 2, where └ ┘ is a ceiling operation, log 2 is a log base 2 operation, and N_{subchannel}^{SL} is a positive integer indicating a number of (available/resource pool) sidelink subchannels; otherwise

$$⌈ {log}_{2} ( \frac{{N}_{subChannel}^{S L} ( {N}_{subChannel}^{S L} + 1 ) ( 2 {N}_{subChannel}^{S L} + 1 )}{6} ) ⌉$$

bits when the value of the higher layer parameter sl-MaxNumPerReserve is configured to 3. The bits of the frequency resource assignment information may be specified as defined at least with reference to clause 8.1.5 UE procedure for determining slots and resource blocks for PSSCH transmission associated with an SCI format 1-A of 3GPP TS 38.214 version 16.5.0 Release 16.

The time resource assignment information of the SCI format 1-A may include 5 bits when the value of the higher layer parameter sl-MaxNumPerReserve is configured to 2; otherwise 9 bits when the value of the higher layer parameter sl-MaxNumPerReserve is configured to 3. The bits of the time resource assignment information may be specified as defined at least with reference to clause 8.1.5 UE procedure for determining slots and resource blocks for PSSCH transmission associated with an SCI format 1-A of 3GPP TS 38.214 version 16.5.0 Release 16.

The resource reservation period information of the SCI format 1-A may include └log₂ N_{rsv_period}┘ bits, where └ ┐ is a ceiling operation, log 2 is a log base 2 operation, and N_{rsv_period} is the number of entries in the higher layer parameter sl-ResourceReservePeriodList, if higher layer parameter sl-MultiReserveResource is configured; 0 bit otherwise. The bits of the resource reservation period information may be specified as defined at least with reference to clause 16.4 UE procedure for transmitting PSCCH of 3GPP TS 38.213 version 16.5.0 Release 16.

The DMRS pattern information of the SCI format 1-A may include [log₂ Nₚₐₜₜₑᵣₙ] bits, where ┌ ┘ is a ceiling operation, log 2 is a log base 2 operation, and Nₚₐₜₜₑᵣₙ is the number of DMRS patterns configured by higher layer parameter sl-PSSCH-DMRS-TimePatternList. The bits of the DMRS pattern information may be specified as defined at least with reference to clause 8.4.1.1.2 0.2 Mapping to physical resources of 3GPP TS 38.211 version 16.2.0 Release 16.

The second stage SCI format information of the SCI format 1-A may include 2 bits. In some implementations, a first value (such as “00”) may indicate a second stage SCI format of SCI format 2-A, a second value (such as “01”) may indicate a second stage SCI format of SCI format 2-B, a third value (such as “10”) may be reserved or indicate an SCI format, and a fourth value (such as “11”) may be reserved or indicate an SCI format. The bits of the second stage SCI format information may be specified as defined at least with reference to Table 8.3.1.1-1 in clause 8.3.1.1 SCI format 1-A of 3GPP TS 38.212 version 16.2.0 Release 16.

The beta_offset indicator information of SCI format 1-A may include 2 bits as provided by higher layer parameter si-BetaOffsets2ndSCI. The bits of the beta_offset indicator information may be specified as defined at least with reference to Table 8.3.1.1-2 in clause 8.3.1.1 SCI format 1-A of 3GPP TS 38.212 version 16.2.0 Release 16

The number of DMRS ports of SCI format 1-A may include 1 bit. The bits of the number of DMRS ports may be specified as defined at least with reference to Table 8.3.1.1-3 in clause 8.3.1.1 SCI format 1-A of 3GPP TS 38.212 version 16.2.0 Release 16.

The MSC information of SCI format 1-A may include 5 bits. The bits of the MSC information may be specified as defined at least with reference to clause 8.1.3 Modulation order, target code rate, redundancy version and transport block size determination of 3GPP TS 38.214 version 16.5.0 Release 16.

The MCS table indicator of SCI format 1-A may include 1 bit if one MCS table is configured by higher layer parameter sl-Additional-MCS-Table; 2 bits if two MCS tables are configured by higher layer parameter sl-Additional-MCS-Table; 0 bit otherwise. The bits of the MCS table indicator may be specified as defined at least with reference to clause 8.1.3.1 Modulation order and target code rate determination of 3GPP TS 38.214 version 16.5.0 Release 16:

The PSFCH overhead indication information of SCI format 1-A may include 1 bit if higher layer parameter sl-PSFCH-Period=2 or 4; 0 bit otherwise. The bits of the PSFCH overhead indication information may be specified as defined at least with reference to clause 8.1.3.2 Transport block size determination of 3GPP TS 38.214 version 16.5.0 Release 16.

The reserved information of SCI format 1-A may include a number of bits as determined by higher layer parameter sl-NumReservedBits. In some implementations, the number of bits may be set to zero.

The SCI-2 may include one or more fields. As an illustrative, non-limiting example, the one or more fields of SCI-2 may include or indicate a HARQ process ID, NDI, a source ID, a destination ID, a CSI report trigger (applicable to unicast only), transmission block (TB) information (such as information to determine a TB transmission or a new TB), or a combination thereof. For group cast implementations associated with NACK-only distance-based feedback, the SCI-2 may include or indicate a zone ID indicating the location of the transmitter, a maximum communication range for sending feedback, or a combination thereof. The SCI-2 may have an SCI format 2-A, an SCI format 2-B, or another SCI format.

In some implementations, the SCI-1 may have an SCI format 2-A, which may be used for the decoding of PSSCH, with HARQ operation when HARQ-ACK information includes ACK or NACK, when HARQ-ACK information includes only NACK, or when there is no feedback of HARQ-ACK information. The SCI format 2-A may include or indicate HARQ process number information, a new data indicator, redundancy version information, source ID information, destination ID information, a HARQ feedback enabled/disabled indicator, a cast type indicator, CSI request information, or a combination thereof.

The HARQ process number information may include 4 bits. The new data indicator may include 1 bit. The redundancy version information may include 2 bits. The bits of the redundancy version information may be specified as defined at least with reference to Table 7.3.1.1.1-2. In clause 7.3.1.1.1 Format 0_0 of 3GPP TS 38.212 version 16.2.0 Release 16. The source ID information may include 8 bits. The bits of the source ID information may be specified as defined at least with reference to clause 8.1 UE procedure for transmitting the physical sidelink shared channel of 3GPP TS 38.214 version 16.5.0 Release 16. The destination ID information may include 16 bits. The bits of the destination ID information may be specified as defined at least with reference to clause 8.1 UE procedure for transmitting the physical sidelink shared channel of 3GPP TS 38.214 version 16.5.0 Release 16. The HARQ feedback enabled/disabled indicator may include 1 bit. The bit of the HARQ feedback enabled/disabled indicator may be specified as defined at least with reference to clause 16.3 UE procedure for reporting HARQ-ACK on sidelink of 3GPP TS 38.213 version 16.5.0 Release 16.

The cast type indicator may include 2 bits. In some implementations, a first value (such as “00”) may indicate a broadcast cast type, a second value (such as “01”) may indicate a groupcast cast type when HARQ-ACK information includes ACK or NACK, a third value (such as “10”) may indicate a unicast cast type, and a fourth value (such as “11”) may indicate a groupcast cast type when HARQ-ACK information includes only NACK. The bits of the cast type indicator may be specified as defined at least with reference to clause Table 8.4.1.1-1 clause 8.4.1.1 SCI format 2-A of 3GPP TS 38.212 version 16.2.0 Release 16 or clause 8.1 UE procedure for transmitting the physical sidelink shared channel of 3GPP TS 38.214 version 16.5.0 Release 16. The CSI request information may include 1 bit. The bit of the CSI request information may be specified as defined at least with reference to clause 8.2.1 CSI-RS transmission procedure of 3GPP TS 38.214 version 16.5.0 Release 16 or clause 8.1 UE procedure for transmitting the physical sidelink shared channel of 3GPP TS 38.214 version 16.5.0 Release 16.

In some implementations, the SCI-1 may have an SCI format 2-AB, which may be used for the decoding of PSSCH, with HARQ operation when HARQ-ACK information includes only NACK, or when there is no feedback of HARQ-ACK information. The SCI format 2-B may include or indicate HARQ process number information, a new data indicator, redundancy version information, source ID information, destination ID information, a HARQ feedback enabled/disabled indicator, zone ID information, communication range requirement information, or a combination thereof.

The HARQ process number information may include 4 bits. The new data indicator may include 1 bit. The redundancy version information may include 2 bits. The bits of the redundancy version information may be specified as defined at least with reference to Table 7.3.1.1.1-2 in clause 7.3.1.1.1 Format 0_0 of 3GPP TS 38.212 version 16.2.0 Release 16. The source ID information may include 8 bits. The bits of the source ID information may be specified as defined at least with reference to clause 8.1 UE procedure for transmitting the physical sidelink shared channel of 3GPP TS 38.214 version 16.5.0 Release 16. The destination ID may include 16 bits. The bits of the source ID information may be specified as defined at least with reference to clause 8.1 UE procedure for transmitting the physical sidelink shared channel of 3GPP TS 38.214 version 16.5.0 Release 16. The HARQ feedback enabled/disabled indicator may include 1 bit. The bit of the HARQ feedback enabled/disabled indicator may be specified as defined at least with reference to clause 16.3 UE procedure for reporting HARQ-ACK on sidelink of 3GPP TS 38.213 version 16.5.0 Release 16. The zone ID information may include 12 bits. The bits of the zone ID information may be specified as defined at least with reference to clause 5.8.11 Zone identity calculation of 3GPP TS 38.331 version 16.4.1 Release 16. The communication range requirement information may include 4 bits and may be determined by higher layer parameter sl-ZoneConfigMCR-Index.

In some implementations, SCI, such as SCI-1 or SCI-2 may be configured or formatted for sidelink positioning reference signal (SL-PRS) information. For example, a portion of SCI-1 having SCI format 1-A may be interpreted for SL-PRS. Additionally, or alternatively, an SCI-2 may have a format associated with SL-PRS.

An SCI-1 having SCI format 1-A that has at least a portion interpreted for SL-PRS may be associated with a SCI-2 or may not be associated with an SCI-2 (e.g., no SCI-2 is need to schedule SL-PRS). In either case of the portion of the SCI-1 being interpreted for SL-PRS, the size of SCI-1 should be the same as defined by SCI format 1-A. In some implementations, a UE may receive a high-layer configuration, such as a higher layer parameter, that indicates to interpret the SCI-1 as the SL-PRS SCI-1 or to interpret an SCI-2, or a portion thereof, as an SL-PRS SCI-2.

In some implementations, the SCI-1, such as the SCI-I having SCI format 1-A, may include a plurality of fields, such as a priority field, a frequency resource assignment field, a time resource assignment field, a resource reservation period field, a demodulation reference signal (DMRS) pattern field, a second stage sidelink control information format field, a beta offset indicator field, a number of DMRS port field, a modulation and coding scheme (MCS) field, an MCS table indicator field, a physical sidelink feedback channel (PSFCH) overhead indication field, a reserved field, or a combination thereof.

In some implementations where the SCI-1 having SCI format 1-A is not associated with an SCI-2 (e.g., no SCI-2 is need to schedule SL-PRS), the portion interpreted for SL-PRS may include one or more fields of the SCI-1. The one or more fields may include the DMRS pattern field, the second stage sidelink control information format field, the beta offset indicator field, the number of DMRS port field, the MCS field, the MCS table indicator field, the PSFCH overhead indication field, the reserved field, or a combination thereof. The one or more fields interpreted for SL-PRS may include information, such as a sidelink position reference signal configuration, SL-PRS scheduling information, positioning type session information that indicates positioning type session information, or a combination thereof. The positioning type session information may include or indicate roundtrip time (RTT), time difference of arrival (TDOA), angle of arrival (AoA), angle of departure (AoD), source device operation information, destination operation information, or a combination thereof. The priority field, the time resource field, the frequency resource field, the resource reservation field, or a combination thereof may not be interpreted for SL-PRS and may be interpreted by legacy UEs, such as a UE that does not support sidelink communication.

In some implementations where the SCI-1 having SCI format 1-A is associated with an SCI-2 (such as a SCI-2 having a format associated with or for SL-PRS scheduling), the portion interpreted for SL-PRS may include one or more fields of the SCI-1. The one or more fields may include the PSFCH overhead indication field, the reserved field, or a combination thereof. The one or more fields interpreted for SL-PRS may include information, such as a sidelink position reference signal configuration, SL-PRS scheduling information, positioning type session information that indicates positioning type session information, or a combination thereof. The positioning type session information may include or indicate RTT, TDOA, AoA, AoD, source device operation information, destination operation information, or a combination thereof. The priority field, the time resource field, the frequency resource field, the resource reservation field, or a combination thereof may not be interpreted for SL-PRS and may be interpreted by legacy UEs, such as a UE that does not support sidelink communication. In some implementations, the SCI-1 may indicate the SCI-2 having a format associated with or for SL-PRS scheduling using the second stage sidelink control information format field.

In some implementations, the SCI-2 may have a format associated with or for SL-PRS scheduling. A UE may be configured to interpret or decode the SCI-2 to identify SL-PRS information, such as SL-PRS scheduling information. In some implementations, a UE may receive an SCI-1 or a high-layer configuration, such as a higher layer parameter, that indicates to interpret the SCI-2, or a portion thereof, as an SL-PRS SCI-2.

Referring to FIGS. 4-7, FIGS. 4-7 are block diagrams of examples of an SCI-2. Referring to FIG. 4, a block diagram of an example of an SCI-2 400 is shown. SCI-2 400 includes a plurality of blocks, such as a first block 402, a second block 404, and a third block 406. Although three blocks are shown, in other implementations, SCI-2 400 may include fewer or more than three blocks. Each block of the plurality of blocks includes one or more fields. One or more of the fields may be common (e.g., the same) for two or more blocks. For example, two or more blocks may include a source ID field. The source ID field may include one or more bits that indicate or identify UE 315. In some implementations, the source ID field may be defined by a standard. For example, the source ID fields may include 8 bits as defined in clause 8.1 UE procedure for transmitting the physical sidelink shared channel of 3GPP TS 38.214 version 16.5.0 Release 16.

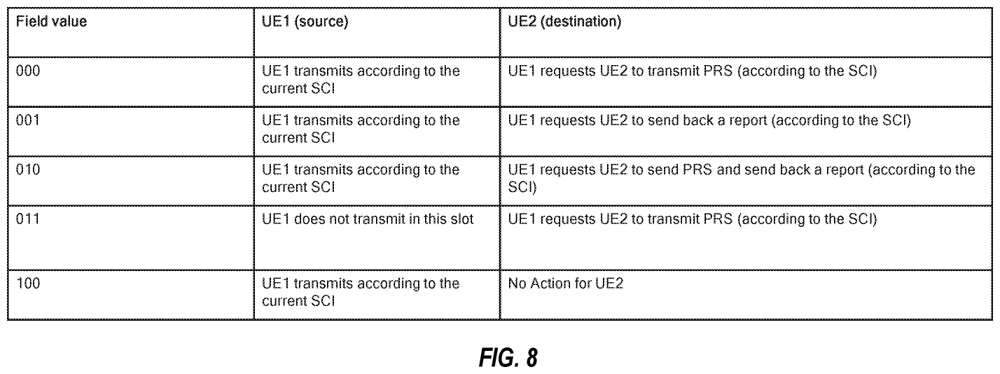

Each block may be configured for one or more UEs. In some implementations, each block includes a positioning type session field, a destination ID field, a PRS trigger bitfield field, or a combination thereof. The positioning type session field indicates RTT, TDOA, AoA, or AoD. Additionally, or alternatively, the positioning type session field may indicates source device operation information, destination operation information, or a combination thereof. The positioning type session field may also include or indicate a value as described with reference to FIG. 8. The destination ID field may include or indicate a UE, such as UE 350. The PRS trigger bitfield may include or indicate a location, such as a symbol or slot, a trigger condition, or a combination thereof, associated with a positioning reference signal (PRS).

UE 350 may have a high-layer, such as higher layer parameter 359, which points to a starting bit of an SCI-2 payload, such as a block, that is configured for UE 350. In some implementations, the higher layer parameter is startingbitIndexForSC2. Additionally, or alternatively, UE 350 also may be configured with the size of the block that UE 350 should use.

In some implementations, UE 350 is configured with multiple higher layer parameters (e.g., 359), such as multiple startingbitIndexForSC2s, multiple block sizes, or a combination thereof. Each of the multiple layer parameters may be associated with or correspond to a source ID or a positioning session ID. UE 350 may select a higher layer parameter of the multiple higher layer parameters based on a source ID, such as a source ID of UE 315, or a positioning session ID. UE 350 may access a block of SCI-2 400 based on the selected higher layer parameter.

Referring to FIG. 5, a block diagram of an example of an SCI-2 500 is shown. SCI-2 500 includes a plurality of blocks, such as a first block 502, a second block 504, and a third block 506. Although three blocks are shown, in other implementations, SCI-2 500 may include fewer or more than three blocks. Each block of the plurality of blocks includes one or more fields.

First block 502, such as an initial block, includes a source ID field 510. Source ID field 510 may include one or more bits that indicate or identify UE 315. In some implementations, the source ID field 510 may be defined by a standard. For example, source ID field 510 may include 8 bits as defined in clause 8.1 UE procedure for transmitting the physical sidelink shared channel of 3GPP TS 38.214 version 16.5.0 Release 16. Source ID field 510 may be applicable to one or more other blocks of the plurality of blocks. In some implementations, source ID field 510 is applicable to each other block of the plurality of blocks.

One or more blocks of the plurality of blocks other than first block 502 may include a positioning type session field, a destination ID field, a PRS trigger bitfield field, or a combination thereof. The positioning type session field indicates RTT, TDOA, AoA, or AoD. Additionally, or alternatively, the positioning type session field may indicates source device operation information, destination operation information, or a combination thereof. A value as described with reference to FIG. 8. The destination ID field may include or indicate a UE, such as UE 350. The PRS trigger bitfield may include or indicate a location, such as a symbol or slot, a trigger condition, or a combination thereof, associated with a PRS.

Referring to FIG. 6, a block diagram of an example of an SCI-2 600 is shown. SCI-2 600 includes a plurality of blocks, such as a first block 602, a second block 604, and a third block 606. Although three blocks are shown, in other implementations, SCI-2 600 may include fewer or more than three blocks. Each block of the plurality of blocks includes one or more fields.

First block 602, such as an initial block, includes a source ID field 610 and a positioning type session field 620. Source ID field 610 may include one or more bits that indicate or identify UE 315. In some implementations, source ID field 610 may be defined by a standard. For example, source ID field 610 may include 8 bits as defined in clause 8.1 UE procedure for transmitting the physical sidelink shared channel of 3GPP TS 38.214 version 16.5.0 Release 16. Source ID field 610 may be applicable to each block of the plurality of blocks. Positioning type session field 620 may indicate RTT, TDOA, AoA, or AoD. Additionally, or alternatively, positioning type session field 620 may indicates source device operation information, destination operation information, or a combination thereof. Positioning type session field 620 may also include or indicate a value as described with reference to FIG. 8. Source ID field 610 and positioning type session field 620 may be applicable to one or more other blocks of the plurality of blocks. In some implementations, source ID field 610 and positioning type session field 620 are applicable to each other block of the plurality of blocks.

One or more blocks of the plurality of blocks other than first block 502 may include a destination ID field, a PRS trigger bitfield field, or a combination thereof. The destination ID field may include or indicate a UE, such as UE 350. The PRS trigger bitfield may include or indicate a location, such as a symbol or slot, a trigger condition, or a combination thereof, associated with a PRS.

Referring to FIG. 7, a block diagram of an example of an SCI-2 700 is shown. SCI-2 700 includes a plurality of blocks, such as a first block 702 and a second block 704. Although two blocks are shown, in other implementations, SCI-2 700 may include more than two blocks. Each block of the plurality of blocks includes one or more fields.

First block 702, such as an initial block, includes a source ID field 710. Source ID field 710 may include one or more bits that indicate or identify UE 315. In some implementations, source ID field 710 may be defined by a standard. For example, source ID field 710 may include 8 bits as defined in clause 8.1 UE procedure for transmitting the physical sidelink shared channel of 3GPP TS 38.214 version 16.5.0 Release 16. Source ID field 710 may be applicable to each block of the plurality of blocks.

One or more block of the plurality of block, other than first block 702, may include one or more sub-blocks. For example, second block 704 includes a first sub-block 730, a second sub-block 732, and a third sub-block 734. Although three sub-blocks are shown, in other implementations, second block 704 may include fewer or more than three sub-blocks.

First sub-block 730, such as an initial sub-block of second block 704, includes a positioning type session field 720. Positioning type session field 720 may indicate RTT, TDOA, AoA, or AoD. Additionally, or alternatively, positioning type session field 720 may indicates source device operation information, destination operation information, or a combination thereof. Positioning type session field 720 may also include or indicate a value as described with reference to FIG. 8. Positioning type session field 720 may be applicable to one or more other sub-blocks of the second block 704. In some implementations, positioning type session field 720 is applicable to each other sub-block of second block 704.

One or more sub-blocks of the plurality of sub-blocks (of second block 704) other than first sub-block 730 may include a destination ID field, a PRS trigger bitfield field, or a combination thereof. The destination ID field may include or indicate a UE, such as UE 350. The PRS trigger bitfield may include or indicate a location, such as a symbol or slot, a trigger condition, or a combination thereof, associated with a PRS.

FIG. 8 is a block diagram illustrating an example values of a positioning type session field. For example, positioning type session field may include or correspond to positioning type session field 620 or 720 or other positon type session fields of first SCI 380 or second SCI 386, as described herein.

A position type session field may have a value represented by one or more bits. The value may be interpreted to indicate one or more operations to be performed by a source UE, such as UE 315, one or more operations to be performed by a destination UE, such as UE 350, or a combination thereof. In some implementations, the value of the position type session filed is an index value.

Referring to FIG. 8, a first field value, such as “000”, may indicate that a source UE transmits in a slot according to the current SCI, and that a destination UE is requested to transmit PRS (according to the SCI). A second field value, such as “001”, may indicate that a source UE transmits in a slot according to the current SCI, and that a destination UE is requested to send a report (according to the SCI). A third field value, such as “010”, may indicate that a source UE transmits in a slot according to the current SCI, and that a destination UE is requested to transmit PRS and send a report (according to the SCI). A fourth field value, such as “011”, may indicate that a source UE does not transmit in a slot, and that a destination UE is requested to transmit PRS (according to the SCI). A first field value, such as “100”, may indicate that a source UE transmits in a slot according to the current SCI, and that a destination UE is to take no action.

It is noted that the field values and operations described with reference to FIG. 8 are for illustration only. It is to be understood that different field values may be used and that the listed field values or other field values may map to one or more of the same or different operations by the source UE, the destination UE, or both.

Referring again to FIG. 1, during operation of wireless communications system 300, UE 315 and UE 350 are configured to perform one or more operations. For example, UE 315 is configured to generate and transmit first SCI 380. First SCI 380 may include or correspond to SCI-1 having the SCI format 1-A. In some implementations, UE 315 may encode one or more fields of first SCI 380 to be interpreted as SL-PRS information. UE 315 may transmit first SCI 380 to UE 350. UE 350 may receive first SCI 380 and may decode or interpret one or more fields of first SCI 380 to determine SL-PRS information, such as SL-PRS scheduling information 355. In some implementations, UE 315 and UE 350 may perform one or more SL-PRS operations based on first SCI 380. For example, the one or more SL-PRS operations may be performed based on the SL-PRS information interpreted from one or more fields of first SCI 380.

In some implementations where first SCI 380 is not associated with an SCI-2 (e.g., no SCI-2 is need to schedule SL-PRS), UE 315 may not generate and send a second SCI 386. Alternatively, in some implementations, where first SCI 380 is associated with an SCI-2, UE 315 is configured to generate and transmit second SCI 386. For example, second SCI 386 may include or correspond to SCI-2 400, SCI-2 500, SCI-2 600, SCI-2 700, or a combination thereof. UE 350 may receive second SCI 386 and may decode or interpret one or more fields of second SCI 386 to determine SL-PRS information, such as SL-PRS scheduling information 355. In some implementations, UE 315 and UE 350 may perform one or more SL-PRS operations based on second SCI 386. For example, the one or more SL-PRS operations may be performed based on the SL-PRS information interpreted from one or more fields of second SCI 386. The one or more SL-PRS operations may include transmitting an SL-PRS, monitoring for the SL-PRS, measuring the SL-PRS, generating or transmitting a report based on the SL-PRS, determining a position of a source UE or a destination UE, or a combination thereof.

Although UE 315 and UE 350 are described as a source and a destination, respectively, such designation is for ease of explanation. It is noted that in other implementations, UE 315 may be a destination and UE 350 may be a source. Accordingly, each of UE 315 and UE 350 is configured to both encode and decode a first SCI, such as first SCI 380, encode and decode a second SCI, such as second SCI 386, or a combination thereof.

As described with reference to FIG. 3, as well as FIGS. 4-8, the present disclosure provides techniques for use with CSI. Additionally, the techniques may improve position accuracy, reduce overhead communication, and improve system efficiency.

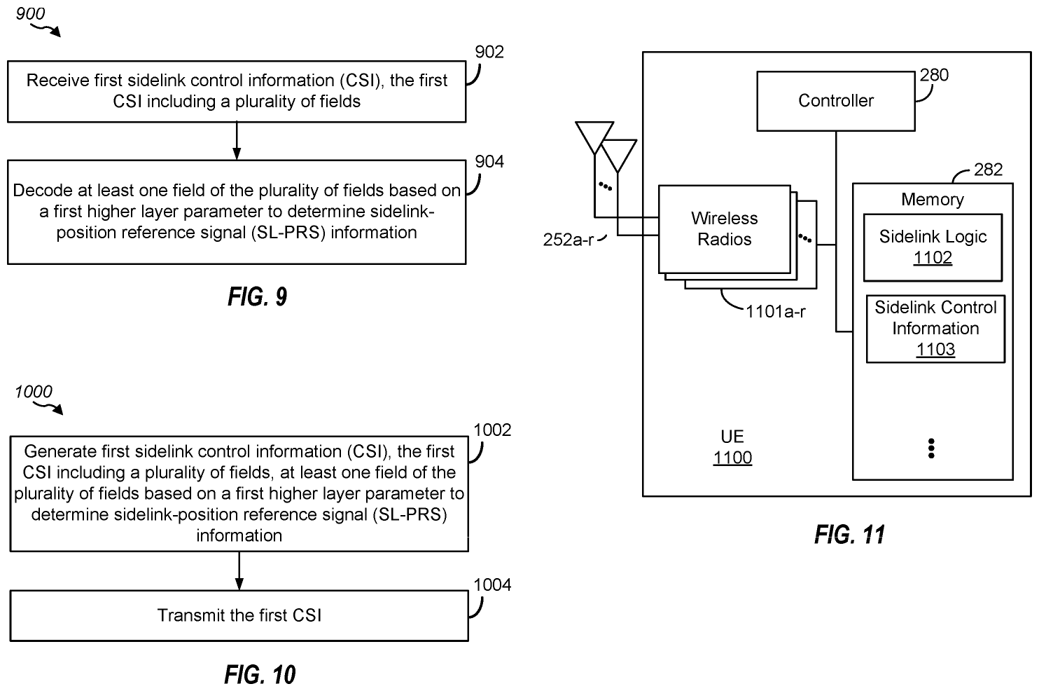

FIG. 9 is a flow diagram illustrating an example process 900 that supports SCI according to one or more aspects. Operations of process 900 may be performed by a UE, such as UE 115 described above with reference to FIG. 1 or 2, or UE 315 or 350 described above with reference to FIG. 3, or a UE as described with reference to FIG. 11. For example, example operations (also referred to as “blocks”) of process 900 may enable UE 115, 315, 350 to support SCI.

In block 902, the UE receives first SCI. The first SCI may include or correspond to first SCI 380. The first SCI including a plurality of fields. For example, the plurality of fields may include a priority field, a frequency resource assignment field, a time resource assignment field, a resource reservation period field, a DMRS pattern field, a second stage sidelink control information format field, a beta offset indicator field, a number of DMRS port field, an MCS field, an MCS table indicator field, a PSFCH overhead indication field, a reserved field, or a combination thereof. In some implementations, the first SCI includes an SCI-1. Additionally, or alternatively, the first SCI may be received on PSCCH.

In block 904, the UE decodes at least one field of the plurality of fields based on a first higher layer parameter to determine SL-PRS information. The first higher layer parameter may include or correspond to higher layer parameter 307 or 359. The first higher layer parameter includes a SL-PRS configuration. In some implementations, the first higher layer parameter is received via RRC signaling or a MAC-CE. The SL-PRS information may include or correspond to SL-PRS scheduling information 306 or 355. In some implementations, the SL-PRS information includes SL-PRS scheduling information, a sidelink position reference signal configuration, or positioning type session information. The positioning type session field may indicate source device operation information, destination operation information, or a combination thereof. Additionally, or alternatively, the positioning type session field may indicate RTT, TDOA, AoA, or AoD. Additionally, or alternatively, the positioning type session field may include a value as described with reference to FIG. 8.

In some implementations, the UE monitors for a positioning reference signal based on the first SCI or based on the SL-PRS information. Additionally, or alternatively, the UE may receive the positioning reference signal and generate a report based on the received positioning reference signal. The UE may transmit the report to another device, such as another UE. In some implementations, the UE transmits a positioning reference signal based on the first SCI or based on the SL-PRS information.

In some implementations, the UE receives a second SCI associated with the first SCI. The second SCI may include to correspond to second SCI 386 of FIG. 3, SCI-2 400 of FIG. 4, SCI-2 500 of FIG. 5, or SCI-2 600 of FIG. 6, or SCI-2 700 of FIG. 7. The second SCI may include an SCI-2. Additionally, or alternatively, the second SCI may include a plurality of blocks. Each block of the plurality of blocks may include one or more fields.

In some implementations, the UE may decode a first block of the plurality of blocks of the second SCI based on a second higher layer parameter. The first block may include second block 404 of FIG. 4. The second higher layer parameter may include or correspond to higher layer parameter 307 or 359. The second higher layer parameter may indicate a starting bit of a block of the plurality of blocks for the UE. For example, the second higher layer parameter may be or may include a start bit index for SCI-2 (startingbitIndexForSC2) parameter. Additionally, or alternatively, the second higher layer parameter may be associated with a source ID of a device that transmitted the second SCI, a positioning session ID (PositioningSessionID), or a combination thereof. In some implementations, the UE may selected the second higher layer parameter from a plurality of second higher layer parameters based on a source ID of a device that transmitted the second SCI. The UE may receive the second higher layer parameter is received via RRC signaling or a MAC-CE.

In some implementations, a first block of the plurality of blocks includes a source ID field. The first block and the source ID may include or correspond to first block 502 and source ID field 510, respectively, of FIG. 5. The source ID field of the first block may be applicable to each block of the plurality of blocks. Each block of the plurality of blocks other than the first block may include a positioning type session field, a destination ID field, a PRS trigger bitfield field, or a combination thereof. The positioning type session field may indicates RTT, TDOA, AoA, or AoD. Additionally, or alternatively, the positioning type session field indicates source device operation information, destination operation information, or a combination thereof.

In some implementations, a first block of the plurality of blocks includes a source ID field and a positioning type session field. The first block, the source ID, and the positioning type session field may include or correspond to first block 602, source ID field 610, and positioning type session field 620, respectively, of FIG. 6. The source ID field and the positioning type session field may be applicable to each block of the plurality of blocks. Each block of the plurality of blocks other than the first block may include a destination ID, a PRS trigger bitfield field, or a combination thereof.

In some implementations, a first block of the plurality of blocks includes a source ID field. The first block and the source ID may include or correspond to first block 702 and source ID field 710, respectively, of FIG. 7. Each block other than the first block of the plurality of blocks may include a plurality of subblocks. A first subblock of a first plurality of subbblocks of a second block of the plurality of blocks may include a positioning type session field that is applicable to each subblock of the first plurality of subblocks. For example, the second block may include or correspond to second block 704 of FIG. 7. The first sub-block and the positioning type session field may include or correspond to first sub-block 730 and positioning type session field 720, respectively, of FIG. 7. Additionally, each subblock of the first plurality of subblocks other than the first subblock of the first plurality of subblocks may include a destination ID, a PRS trigger bitfield field, or a combination thereof.

FIG. 10 is a flow diagram illustrating an example process 1000 that supports SCI according to one or more aspects. Operations of process 1000 may be performed by a UE, such as UE 115 described above with reference to FIG. 1 or 2, or UE 315 or 350 described above with reference to FIG. 3, or a UE as described with reference to FIG. 11. For example, example operations (also referred to as “blocks”) of process 1000 may enable UE 115, 315, 350 to support SCI.

In block 1002, the UE generates first CSI. The first CSI may include or correspond to first SCI 380. In some implementations, the first SCI includes an SCI-1. The first CSI includes a plurality of fields. For example, the plurality of fields may include a priority field, a frequency resource assignment field, a time resource assignment field, a resource reservation period field, a DMRS pattern field, a second stage sidelink control information format field, a beta offset indicator field, a number of DMRS port field, an MCS field, an MCS table indicator field, a PSFCH overhead indication field, a reserved field, or a combination thereof. the at least one field includes the PSFCH overhead indication field and the reserved field. wherein the at least one field includes the PSFCH overhead indication field, the reserved field, or a combination thereof.

At least one field of the plurality of fields is encoded to indicate SL-PRS information. The at least one field may be encoded based on a first higher layer parameter. The first higher layer parameter may include or correspond to higher layer parameter 307 or 359. The first higher layer parameter includes a SL-PRS configuration. In some implementations, the first higher layer parameter is received via RRC signaling or a MAC-CE. The SL-PRS information may include or correspond to SL-PRS scheduling information 306 or 355. In some implementations, the SL-PRS information includes SL-PRS scheduling information, a sidelink position reference signal configuration, or positioning type session information. The positioning type session field may indicate source device operation information, destination operation information, or a combination thereof. Additionally, or alternatively, the positioning type session field may indicate RTT, TDOA, AoA, or AoD. Additionally, or alternatively, the positioning type session field may include a value as described with reference to FIG. 8.

In block 1004, the UE transmits the first CSI. The first SCI may be transmitted on PSCCH.

In some implementations, the UE transmits a positioning reference signal based on the first SCI or based on the SL-PRS information. Additionally, or alternatively, the UE may transmit the positioning reference signal and receive a report based on the received positioning reference signal. The UE may receive the report to another device, such as another UE. In some implementations, the UE monitors for a positioning reference signal based on the first SCI or based on the SL-PRS information.

In some implementations, the UE generates and transmits a second SCI associated with the first SCI. The second SCI may include to correspond to second SCI 386 of FIG. 3, SCI-2 400 of FIG. 4, SCI-2 500 of FIG. 5, or SCI-2 600 of FIG. 6, or SCI-2 700 of FIG. 7. The second SCI may include an SCI-2. Additionally, or alternatively, the second SCI may include a plurality of blocks. Each block of the plurality of blocks may include one or more fields.

In some implementations, the UE may encode a first block of the plurality of blocks of the second SCI based on a second higher layer parameter. The first block may include second block 404 of FIG. 4. The second higher layer parameter may include or correspond to higher layer parameter 307 or 359. The second higher layer parameter may indicate a starting bit of a block of the plurality of blocks for the UE. For example, the second higher layer parameter may be or may include a start bit index for SCI-2 (startingbitIndexForSC2) parameter. Additionally, or alternatively, the second higher layer parameter may be associated with a source ID of a device that transmitted the second SCI, a positioning session ID (PositioningSessionID), or a combination thereof. In some implementations, the UE may selected the second higher layer parameter from a plurality of second higher layer parameters based on a source ID of a device that transmitted the second SCI. The UE may receive the second higher layer parameter is received via RRC signaling or a MAC-CE.

In some implementations, a first block of the plurality of blocks includes a source ID field. The first block and the source ID may include or correspond to first block 502 and source ID field 510, respectively, of FIG. 5. The source ID field of the first block may be applicable to each block of the plurality of blocks. Each block of the plurality of blocks other than the first block may include a positioning type session field, a destination ID field, a PRS trigger bitfield field, or a combination thereof. The positioning type session field may indicates RTT, TDOA, AoA, or AoD. Additionally, or alternatively, the positioning type session field indicates source device operation information, destination operation information, or a combination thereof.

In some implementations, a first block of the plurality of blocks includes a source ID field and a positioning type session field. The first block, the source ID, and the positioning type session field may include or correspond to first block 602, source ID field 610, and positioning type session field 620, respectively, of FIG. 6. The source ID field and the positioning type session field may be applicable to each block of the plurality of blocks. Each block of the plurality of blocks other than the first block may include a destination ID, a PRS trigger bitfield field, or a combination thereof.

In some implementations, a first block of the plurality of blocks includes a source ID field. The first block and the source ID may include or correspond to first block 702 and source ID field 710, respectively, of FIG. 7. Each block other than the first block of the plurality of blocks may include a plurality of subblocks. A first subblock of a first plurality of subbblocks of a second block of the plurality of blocks may include a positioning type session field that is applicable to each subblock of the first plurality of subblocks. For example, the second block may include or correspond to second block 704 of FIG. 7. The first sub-block and the positioning type session field may include or correspond to first sub-block 730 and positioning type session field 720, respectively, of FIG. 7. Additionally, each subblock of the first plurality of subblocks other than the first subblock of the first plurality of subblocks may include a destination ID, a PRS trigger bitfield field, or a combination thereof.

FIG. 11 is a block diagram of an example UE 1100 that supports SCI to one or more aspects. UE 1100 may be configured to perform operations, including the blocks of a process described with reference to FIGS. 9 and 10. In some implementations, UE 1100 includes the structure, hardware, and components shown and described with reference to UE 115 of FIGS. 1-3. For example, UE 1100 includes controller 280, which operates to execute logic or computer instructions stored in memory 282, as well as controlling the components of UE 1100 that provide the features and functionality of UE 1100. UE 1100, under control of controller 280, transmits and receives signals via wireless radios 1101a-r and antennas 252a-r. Wireless radios 1101a-r include various components and hardware, as illustrated in FIG. 2 for UE 115, including modulator and demodulators 254a-r, MIMO detector 256, receive processor 258, transmit processor 264, and TX MIMO processor 266.

As shown, memory 282 may include sidelink logic 1102 and SCI 1103. Sidelink logic 1102 may be configured to perform one or more operations described herein with reference to UE 115, 315, 350. SCI 1103 may include SL-PRS information, such as SL-PRS scheduling information 306 or 355. UE 1100 may receive signals from or transmit signals to one or more network entities, such as another UE 115 or a base station 105 of FIGS. 1-2.

It is noted that one or more blocks (or operations) described with reference to FIGS. 9 and 10 may be combined with one or more blocks (or operations) described with reference to another of the figures. For example, one or more blocks (or operations) of FIG. 9 may be combined with one or more blocks (or operations) of FIG. 10. As another example, one or more blocks associated with FIG. 9 or 10 may be combined with one or more blocks (or operations) associated with FIGS. 1-8.

The following examples are illustrative only and may be combined with aspects of other implementation or teachings described herein, without limitation.

In some aspects, techniques for supporting CSI may include additional aspects, such as any single aspect or any combination of aspects described below or in connection with one or more other processes or devices described elsewhere herein. In a first aspect, techniques for supporting CSI may include receiving first SCI, the first SCI including a plurality of fields; and decoding at least one field of the plurality of fields based on a first higher layer parameter to determine SL-PRS information. In some examples, the techniques in the first aspect may be implemented in a method or process. In some other examples, the techniques of the first aspect may be implemented in a wireless communication device such as a UE, a component of a UE, a network entity, or a component of a network entity. In some examples, the wireless communication device may include at least one processing unit or system (which may include an application processor, one or more processors, a modem or other components) and at least one memory device coupled to the processing unit. The processing unit may be configured to perform operations described herein with respect to the wireless communication device. In some examples, the memory device includes a non-transitory computer-readable medium having program code stored thereon that, when executed by the processing unit, is configured to cause the wireless communication device to perform the operations described herein. Additionally, or alternatively, the wireless communication device may include one or more means configured to perform operations described herein.

In a second aspect, in combination with the first aspect, the first SCI includes an SCI-1 received on PSCCH.

In a third aspect, in combination with the second aspect, the first higher layer parameter includes a SL-PRS configuration.

In a fourth aspect, in combination with one or more of the first aspect through the third aspect, the at least one field includes a PSFCH overhead indication field, a reserved field, or a combination thereof.

In a fifth aspect, in combination with one or more of the first aspect through the fourth aspect, the at least one field includes a DMRS pattern field, a second stage sidelink control information format field, a beta offset indicator field, a number of DMRS port field, a MCS field, an MCS table indicator field, a PSFCH overhead indication field, a reserved field, or a combination thereof.

In a sixth aspect, in combination with one or more of the first aspect through the fifth aspect, the SL-PRS information includes SL-PRS scheduling information.

In a seventh aspect, in combination with one or more of the first aspect through the fifth aspect, the SL-PRS information includes a sidelink position reference signal configuration.

In an eighth aspect, in combination with one or more of the first aspect through the fifth aspect, the SL-PRS information includes: positioning type session information that indicates positioning type session information, the positioning type session information indicates RTT, TDOA, AoA, AoD, source device operation information, destination operation information, or a combination thereof.

In a ninth aspect, in combination with one or more of the first aspect through the eighth aspect, the techniques further include receiving a second SCI associated with the first SCI.

In a tenth aspect, in combination with the ninth aspect, the second SCI includes an SCI-2.

In an eleventh aspect, in combination with the ninth aspect or the tenth aspect, the second SCI includes a plurality of blocks, each block of the plurality of blocks including one or more fields.

In a twelfth aspect, in combination with the eleventh aspect, the techniques further include decoding a first block of the plurality of blocks based on a second higher layer parameter.

In a thirteenth aspect, in combination with the twelfth aspect, the second higher layer parameter indicates a starting bit of a block of the plurality of blocks for the UE.

In a fourteenth aspect, in combination with the twelfth aspect, the second higher layer parameter is associated with a source ID of a device that transmitted the second SCI, a positioning session ID (PositioningSessionID), or a combination thereof.

In a fifteenth aspect, in combination with the eleventh aspect, a first block of the plurality of blocks includes a source ID field, the source ID field is applicable to each block of the plurality of blocks.

In a sixteenth aspect, in combination with the fifteenth aspect, each block of the plurality of blocks other than the first block includes a positioning type session field, a destination ID field, a PRS trigger bitfield field, or a combination thereof.

In a seventeenth aspect, in combination with the eleventh aspect, a first block of the plurality of blocks includes a source ID field and a positioning type session field, the source ID field and the positioning type session field are applicable to each block of the plurality of blocks.

In an eighteenth aspect, in combination with the seventeenth aspect, each block of the plurality of blocks other than the first block includes a destination ID field, a PRS trigger bitfield field, or a combination thereof.

In a nineteenth aspect, in combination with the eleventh aspect, a first block of the plurality of blocks includes a source ID field.

In a twentieth aspect, in combination with the nineteenth aspect, each block other than the first block includes a plurality of subblocks.

In a twenty-first aspect, in combination with the twentieth aspect, a first subblock of a first plurality of subbblocks of a second block of the plurality of blocks includes a positioning type session field that is applicable to each subblock of the first plurality of subblocks.

In a twenty-second aspect, in combination with the twenty-first aspect, each subblock of the first plurality of subblocks other than the first subblock of the first plurality of subblocks includes a destination ID, a PRS trigger bitfield field, or a combination thereof.

In some aspects, techniques for supporting CSI may include additional aspects, such as any single aspect or any combination of aspects described below or in connection with one or more other processes or devices described elsewhere herein. In a twenty-third aspect, techniques for supporting CSI may include generating first SCI, the first SCI including a plurality of fields, at least one field of the plurality of fields encoded to indicate SL-PRS information; and transmitting the first SCI. In some examples, the techniques in the twenty-third aspect may be implemented in a method or process. In some other examples, the techniques of the twenty-third aspect may be implemented in a wireless communication device such as a UE, a component of a UE, a network entity, or a component of a network entity. In some examples, the wireless communication device may include at least one processing unit or system (which may include an application processor, one or more processors, a modem or other components) and at least one memory device coupled to the processing unit. The processing unit may be configured to perform operations described herein with respect to the wireless communication device. In some examples, the memory device includes a non-transitory computer-readable medium having program code stored thereon that, when executed by the processing unit, is configured to cause the wireless communication device to perform the operations described herein. Additionally, or alternatively, the wireless communication device may include one or more means configured to perform operations described herein.

In a twenty-fourth aspect, in combination with the twenty-third, the first SCI includes an SCI-1 transmitted on a PSCCH.

In a twenty-fifth aspect, in combination with the twenty-fourth aspect, the first higher layer parameter includes a SL-PRS configuration.

In a twenty-sixth aspect, in combination with the twenty-third aspect, the at least one field includes a PSFCH overhead indication field, a reserved field, or a combination thereof.

In a twenty-seventh aspect, in combination with the twenty-third, the at least one field includes a DMRS pattern field, a second stage sidelink control information format field, a beta offset indicator field, a number of DMRS port field, an MCS field, an MCS table indicator field, a PSFCH overhead indication field, a reserved field, or a combination thereof.

In a twenty-eighth aspect, in combination with the twenty-third, the SL-PRS information includes: SL-PRS scheduling information.

In a twenty-ninth aspect, in combination with the twenty-third aspect, the SL-PRS information includes: a sidelink position reference signal configuration.

In a thirtieth aspect, in combination with the twenty-third aspect, the SL-PRS information includes positioning type session information that indicates positioning type session information, the positioning type session information indicates RTT, TDOA, AoA, AoD, source device operation information, destination operation information, or a combination thereof.

In a thirty-first aspect, in combination with the twenty-third aspect, the techniques further include transmitting a second SCI associated with the first SCI.

In a thirty-second aspect, in combination with the thirty-first aspect, the second SCI includes an SCI-2.

In a thirty-third aspect, in combination with the thirty-second aspect, the second SCI includes a plurality of blocks, each block of the plurality of blocks including one or more fields.

In a thirty-fourth aspect, in combination with the thirty-third aspect, the techniques further include encoding a first block of the plurality of blocks based on a second higher layer parameter.

In a thirty-fifth aspect, in combination with the thirty-fourth aspect, the second higher layer parameter indicates a starting bit of a block of the plurality of blocks for the UE.

In a thirty-sixth aspect, in combination with the thirty-fifth aspect, the second higher layer parameter is associated with a source ID of a device that transmitted the second SCI, a positioning session ID (PositioningSessionID), or a combination thereof.

In a thirty-seventh aspect, in combination with the thirty-third aspect, a first block of the plurality of blocks includes a source ID field, the source ID field is applicable to each block of the plurality of blocks.

In a thirty-eighth aspect, in combination with the thirty-seventh aspect, each block of the plurality of blocks other than the first block includes a positioning type session field, a destination ID field, a PRS trigger bitfield field, or a combination thereof.

In a thirty-ninth aspect, in combination with the thirty-third aspect, a first block of the plurality of blocks includes a source ID field and a positioning type session field, the source ID field and the positioning type session field are applicable to each block of the plurality of blocks.

In a fortieth aspect, in combination with the thirty-ninth aspect, each block of the plurality of blocks other than the first block includes a destination ID field, a PRS trigger bitfield field, or a combination thereof.

In a forty-first aspect, in combination with the fortieth aspect, a first block of the plurality of blocks includes a source ID field.

In a forty-second aspect, in combination with the forty-first aspect, each block other than the first block includes a plurality of subblocks.

In a forty-third aspect, in combination with the forty-second aspect, a first subblock of a first plurality of subbblocks of a second block of the plurality of blocks includes a positioning type session field that is applicable to each subblock of the first plurality of subblocks.

In a forty-fourth aspect, in combination with the forty-third aspect, each subblock of the first plurality of subblocks other than the first subblock of the first plurality of subblocks includes a destination ID, a PRS trigger bitfield field, or a combination thereof.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-11 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication comprising:
receiving first sidelink control information (SCI), the first SCI including a plurality of fields; and
decoding at least one field of the plurality of fields based on a first higher layer parameter to determine sidelink-position reference signal (SL-PRS) information.

2. The method of claim 1, wherein:
the first SCI includes a first stage control SCI (SCI-1) received on a physical sidelink control channel (PSCCH); and
the first higher layer parameter includes a SL-PRS configuration.

3. The method of claim 1, wherein the at least one field includes a physical sidelink feedback channel (PSFCH) overhead indication field, a reserved field, or a combination thereof.

4. The method of claim 1, wherein the at least one field includes a demodulation reference signal (DMRS) pattern field, a second stage sidelink control information format field, a beta offset indicator field, a number of DMRS port field, a modulation and coding scheme (MCS) field, an MCS table indicator field, a PSFCH overhead indication field, a reserved field, or a combination thereof.

5. The method of claim 1, wherein the SL-PRS information includes:
SL-PRS scheduling information;
a sidelink position reference signal configuration; or
positioning type session information that indicates positioning type session information, the positioning type session information indicates roundtrip time (RTT), time difference of arrival (TDOA), angle of arrival (AoA), angle of departure (AoD), source device operation information, destination operation information, or a combination thereof.

6. The method of claim 1, further comprising:
receiving a second SCI associated with the first SCI; and
wherein the second SCI includes a second stage control SCI (SCI-2); and
wherein the second SCI includes a plurality of blocks, each block of the plurality of blocks including one or more fields.

7. The method of claim 6, further comprising:
decoding a first block of the plurality of blocks based on a second higher layer parameter; and
wherein the second higher layer parameter indicates a starting bit of a block of the plurality of blocks for a user equipment (UE), and
wherein the second higher layer parameter is associated with a source ID of a device that transmitted the second SCI, a positioning session ID (PositioningSessionID), or a combination thereof.

8. The method of claim 6, wherein:
a first block of the plurality of blocks includes a source ID field, the source ID field is applicable to each block of the plurality of blocks; and
each block of the plurality of blocks other than the first block includes a positioning type session field, a destination ID field, a PRS trigger bitfield field, or a combination thereof.

9. The method of claim 6, wherein:
a first block of the plurality of blocks includes a source ID field and a positioning type session field, the source ID field and the positioning type session field are applicable to each block of the plurality of blocks; and
each block of the plurality of blocks other than the first block includes a destination ID field, a PRS trigger bitfield field, or a combination thereof.

10. The method of claim 6 wherein:
a first block of the plurality of blocks includes a source ID field;
each block other than the first block includes a plurality of subblocks;
a first subblock of a first plurality of subbblocks of a second block of the plurality of blocks includes a positioning type session field that is applicable to each subblock of the first plurality of subblocks; and
each subblock of the first plurality of subblocks other than the first subblock of the first plurality of subblocks includes a destination ID, a PRS trigger bitfield field, or a combination thereof.

11. A user equipment (UE) comprising:
a memory storing processor-readable code; and
at least one processor coupled to the memory, the at least one processor configured to execute the processor-readable code to cause the at least one processor to:
receive first sidelink control information (SCI), the first SCI including a plurality of fields; and
decode at least one field of the plurality of fields based on a first higher layer parameter to determine sidelink-position reference signal (SL-PRS) information.

12. The UE of claim 11, wherein the at least one processor is further configured to execute the processor-readable code to cause the at least one processor to:
receive a second SCI associated with the first SCI, the second SCI includes a plurality of blocks, each block of the plurality of blocks including one or more fields; and
decode a first block of the plurality of blocks based on a second higher layer parameter; and
wherein the second higher layer parameter indicates a starting bit of a block of the plurality of blocks for the UE; and
wherein the second higher layer parameter is associated with a source ID of a device that transmitted the second SCI, a positioning session ID (PositioningSessionID), or a combination thereof.

13. The UE of claim 11, wherein the at least one processor is further configured to execute the processor-readable code to cause the at least one processor to:
receive a second SCI associated with the first SCI, the second SCI includes a plurality of blocks, each block of the plurality of blocks including one or more fields; and
wherein a first block of the plurality of blocks includes a source ID field, the source ID field is applicable to each block of the plurality of blocks; and
wherein each block of the plurality of blocks other than the first block includes a positioning type session field, a destination ID field, a PRS trigger bitfield field, or a combination thereof.

14. The UE of claim 11, wherein the at least one processor is further configured to execute the processor-readable code to cause the at least one processor to:
receive a second SCI associated with the first SCI, the second SCI includes a plurality of blocks, each block of the plurality of blocks including one or more fields; and
wherein a first block of the plurality of blocks includes a source ID field and a positioning type session field, the source ID field and the positioning type session field are applicable to each block of the plurality of blocks; and
wherein each block of the plurality of blocks other than the first block includes a destination ID field, a PRS trigger bitfield field, or a combination thereof.

15. The UE of claim 11, wherein the at least one processor is further configured to execute the processor-readable code to cause the at least one processor to:
receive a second SCI associated with the first SCI, the second SCI includes a plurality of blocks, each block of the plurality of blocks including one or more fields; and
wherein:
a first block of the plurality of blocks includes a source ID field;
each block other than the first block includes a plurality of subblocks;
a first subblock of a first plurality of subbblocks of a second block of the plurality of blocks includes a positioning type session field that is applicable to each subblock of the first plurality of subblocks; and
each subblock of the first plurality of subblocks other than the first subblock of the first plurality of subblocks includes a destination ID, a PRS trigger bitfield field, or a combination thereof.

16. A method of wireless communication comprising:
generating first sidelink control information (SCI), the first SCI including a plurality of fields, at least one field of the plurality of fields encoded to indicate sidelink-position reference signal (SL-PRS) information; and
transmitting the first SCI.

17. The method of claim 16, wherein:
the first SCI includes a first stage control SCI (SCI-1) transmitted on a physical sidelink control channel (PSCCH); and
the first SCI is generated based on a first higher layer parameter associated with an SL-PRS configuration.

18. The method of claim 16, wherein the at least one field includes a physical sidelink feedback channel (PSFCH) overhead indication field, a reserved field, or a combination thereof.

19. The method of claim 16, wherein the at least one field includes a demodulation reference signal (DMRS) pattern field, a second stage sidelink control information format field, a beta offset indicator field, a number of DMRS port field, a modulation and coding scheme (MCS) field, an MCS table indicator field, a PSFCH overhead indication field, a reserved field, or a combination thereof.

20. The method of claim 16, wherein the SL-PRS information includes:
SL-PRS scheduling information;
a sidelink position reference signal configuration; or
positioning type session information that indicates positioning type session information, the positioning type session information indicates roundtrip time (RTT), time difference of arrival (TDOA), angle of arrival (AoA), angle of departure (AoD), source device operation information, destination operation information, or a combination thereof.

21. The method of claim 16, further comprising:
transmitting a second SCI associated with the first SCI; and
wherein the second SCI includes a second stage control SCI (SCI-2); and
wherein the second SCI includes a plurality of blocks, each block of the plurality of blocks including one or more fields.

22. The method of claim 21, further comprising:
encoding a first block of the plurality of blocks based on a second higher layer parameter; and
wherein the second higher layer parameter indicates a starting bit of a block of the plurality of blocks for a user equipment (UE); and
wherein the second higher layer parameter is associated with a source ID of a device that transmitted the second SCI, a positioning session ID (PositioningSessionID), or a combination thereof.

23. The method of claim 21, wherein:
a first block of the plurality of blocks includes a source ID field, the source ID field is applicable to each block of the plurality of blocks; and
each block of the plurality of blocks other than the first block includes a positioning type session field, a destination ID field, a PRS trigger bitfield field, or a combination thereof.

24. The method of claim 21, wherein:
a first block of the plurality of blocks includes a source ID field and a positioning type session field, the source ID field and the positioning type session field are applicable to each block of the plurality of blocks; and
each block of the plurality of blocks other than the first block includes a destination ID field, a PRS trigger bitfield field, or a combination thereof.

25. The method of claim 21, wherein:
a first block of the plurality of blocks includes a source ID field;
each block other than the first block includes a plurality of subblocks;
a first subblock of a first plurality of subbblocks of a second block of the plurality of blocks includes a positioning type session field that is applicable to each subblock of the first plurality of subblocks; and
each subblock of the first plurality of subblocks other than the first subblock of the first plurality of subblocks includes a destination ID, a PRS trigger bitfield field, or a combination thereof.

26. A user equipment (UE) comprising:
a memory storing processor-readable code; and
at least one processor coupled to the memory, the at least one processor configured to execute the processor-readable code to cause the at least one processor to:
generate first SCI, the first SCI including a plurality of fields, at least one field of the plurality of fields encoded to indicate sidelink-position reference signal (SL-PRS) information; and
initiate transmission of the first SCI.

27. The UE of claim 26, wherein the at least one processor is further configured to execute the processor-readable code to cause the at least one processor to:
initiate transmission of a second SCI associated with the first SCI, the second SCI includes a plurality of blocks, each block of the plurality of blocks including one or more fields; and
encode a first block of the plurality of blocks based on a second higher layer parameter; and
wherein the second higher layer parameter indicates a starting bit of a block of the plurality of blocks for the UE; and
wherein the second higher layer parameter is associated with a source ID of a device that transmitted the second SCI, a positioning session ID (PositioningSessionID), or a combination thereof.

28. The UE of claim 26, wherein the at least one processor is further configured to execute the processor-readable code to cause the at least one processor to:
initiate transmission of a second SCI associated with the first SCI, the second SCI includes a plurality of blocks, each block of the plurality of blocks including one or more fields; and
wherein a first block of the plurality of blocks includes a source ID field, the source ID field is applicable to each block of the plurality of blocks; and
wherein each block of the plurality of blocks other than the first block includes a positioning type session field, a destination ID field, a PRS trigger bitfield field, or a combination thereof.

29. The UE of claim 26, wherein the at least one processor is further configured to execute the processor-readable code to cause the at least one processor to:
initiate transmission of a second SCI associated with the first SCI, the second SCI includes a plurality of blocks, each block of the plurality of blocks including one or more fields; and
wherein a first block of the plurality of blocks includes a source ID field and a positioning type session field, the source ID field and the positioning type session field are applicable to each block of the plurality of blocks; and
wherein each block of the plurality of blocks other than the first block includes a destination ID field, a PRS trigger bitfield field, or a combination thereof.

30. The UE of claim 26, wherein the at least one processor is further configured to execute the processor-readable code to cause the at least one processor to:
initiate transmission of a second SCI associated with the first SCI, the second SCI includes a plurality of blocks, each block of the plurality of blocks including one or more fields; and
wherein:
a first block of the plurality of blocks includes a source ID field;
each block other than the first block includes a plurality of subblocks;
a first subblock of a first plurality of subbblocks of a second block of the plurality of blocks includes a positioning type session field that is applicable to each subblock of the first plurality of subblocks; and
each subblock of the first plurality of subblocks other than the first subblock of the first plurality of subblocks includes a destination ID, a PRS trigger bitfield field, or a combination thereof.
